(19) United States
(12) Patent Application Publication
(10) Pub. No.: US 2009/0002726 A1
(43) Pub. Date: Jan. 1, 2009

(54) RASTER IMAGE PROCESSING OF HOLD JOBS WHEN DIGITAL FRONT END IS IDLE

(75) Inventor: Nicholas P. OSADCIW, Webster, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/768,597

(22) Filed: Jun. 26, 2007

(51) Int. Cl. G06F 15/00

(52) U.S. Cl. 358/1.6; 358/1.15; 358/448

(57) ABSTRACT

Digital front end (DFE) raster image processing (RIP) performance is enhanced by automatically releasing and raster image processing held jobs, saving the print ready pages produced for later output. In this way, when an operator moves one of the held jobs to an active state, the job immediately starts printing, as there is no raster image processing required. A method for deciding when to release another held job is based on whether the digital front end or printer are idle or busy and may be suspended when disk space or other resources are unavailable or an interrupt is received. Advantages include improvement in the digital front end raster image processing rate and utilization of idle system resources to build a backlog of jobs or pages for output, without effecting normal digital front end print operations.

### BACKGROUND

This disclosure generally relates to digital imaging systems and specifically relates to improving the speed and performance of the image processing performed for printing, copying, scanning and the like.

A raster image processor (RIP) provides output data in a format that is suitable for rendering by an output device. One suitable format is raw, binary dot patterns forming a bitmap. Rendering by the output device may include printing by a printer, displaying on a screen, and scanning by a scanner. The raster image processor receives input of one or more page descriptions. The page descriptions includes information about fonts, graphics, and the like that describe the appearance of each page. The page descriptions may be in a high level language or even another bitmap of higher or lower resolution than the output device. Some examples of high level page description languages are PostScript (PS), Portable Document Format (PDF) and Extensible Markup Language (XML) Paper Specification (XPS). The raster image processor may be implemented either as software, firmware, or hardware. Typically, the raster image processor resides in a digital front end (DFE). The raster image processor performs raster image processing (RIPping). Raster image processing is the process of translating the page descriptions into a bitmap for output by the output device (e.g., desktop printer).

Raster image processing for some files may take an unreasonably long time to process. Often, this is true for large files containing color graphics and/or variable data. Files containing color graphics by their nature tend have large page descriptions and correspondingly large bitmaps. Variable data files allow documents to be customized or personalized. With the increase in demand for color and personalized communications, there has been a noticeable decrease in performance of raster image processors.

Variable data jobs include page descriptions with variable data and fixed data. Fixed data refers to data that remains constant over the image processing of the documents in a project. Variable data refers to data that varies between the documents in the job. A job is one or more documents having the same fixed data and optionally variable data. A document refers to one or more pages in a project corresponding to a set or record of variable data. Examples of jobs containing both variable and fixed data include personalized direct mail, business forms, custom calendars, personalized checks and the like. For a personalized job, a number of copies of the documents are processed where each copy may be uniquely customized for the intended recipient. The pages of the copies may be composed of text, graphics, and images that may be unique to just that copy, identical on every copy, or used on some copies but not on others. For example, in a customized product brochure, unique elements may include the recipient's name and address, while the product company name and logo are identical on every copy. A picture of a specific product of interest to the recipient may be found on some copies, but not on others.

For example, consider a standard or non-variable job to make a thousand copies of a hundred page document. The raster image processor receives page descriptions for the document and produces a single bitmap that is used by the output device a thousand times to make all of the copies. Contrast this standard job example to a variable data job example. The variable data job is to make a thousand copies of a hundred page document where each copy is customized or personalized. The raster image processor receives page descriptions for the document and produces a thousand bitmaps that are each used once by the output device to make one of the copies. As a result, raster image processing of the variable data job takes considerably longer. Even on, for example, a hundred page per minute printer, the printer would only be able to print about 20 pages per minute for such a variable data job.

Raster image processing of page descriptions is one of the most significant bottlenecks in a production printing system. Raster image processor rates for complex color and variable data jobs are often slower than printer output rates. Such features are causing page descriptions to be raster image processed at a rate slower than the print engine speed of many printers. Variable data files ripping at about 10-20% of the print engine speed have been observed.

### SUMMARY

Exemplary embodiments include a method of raster image processing held jobs when a digital front end is idle. When it is determined that the digital front end is idle, one or more held jobs are raster image processed, producing one or more bitmaps, which may be stored in a memory associated with the digital front end. The stored bitmap may then be sent to an output device for rendering, after determining that the held job was already raster image processed and retrieving the bitmap from the memory. The retrieved bitmap is sent to the output device for rendering, without additional raster image processing. The oldest held job may be retrieved. A regular job may interrupt the raster image processing of the held job to process a priority job. In this case, the raster image processing of the held job is suspended and context information about the partial bitmap produced for the held job may be stored. When the digital front end again becomes idle, raster image processing of the held job may be resume using the stored context information. When regular jobs are being raster image processed and memory is low, bitmaps for held jobs may be purged from memory to make room for the bitmap produced for the regular job. Another exemplary embodiment is a computer readable medium storing instructions for performing this method.

Another exemplary embodiment is a digital front end for raster image processing held jobs when the digital front end is idle. The digital front end includes a system controller, a raster image processor and a memory. The system controller receives the page description and forms them into jobs. Some jobs are held jobs and other jobs are regular jobs. The raster image processor raster image processes one or more of the held jobs to produce bitmaps while the digital front end is idle. The memory stores the bitmaps for the held jobs. The digital front end may also include a print service. The print service communicates with the system controller and receives the page descriptions from the submission client. The digital front may also include one or more queues for holding the jobs. The queues may include a print queue and a hold queue. The digital front end may also include a print engine connected to the digital front end for receiving the bitmaps.

### BRIEF DESCRIPTION OF THE DRAWINGS

FIG. 1 illustrates an exemplary embodiment of a networked printing system architecture;

FIG. 2 illustrates an exemplary embodiment of a method for raster image processing of a held job;

FIGS. 3A and 31 illustrate an exemplary embodiment of a method for the raster image processing of a held job that is interrupted by a regular job moving to the print queue; and

FIGS. 3C and 3D illustrate an exemplary embodiment of a method for the raster image processing of a regular job when the system controller purges one or more pre-raster image processed held jobs due to memory constraints.

### EMBODIMENTS

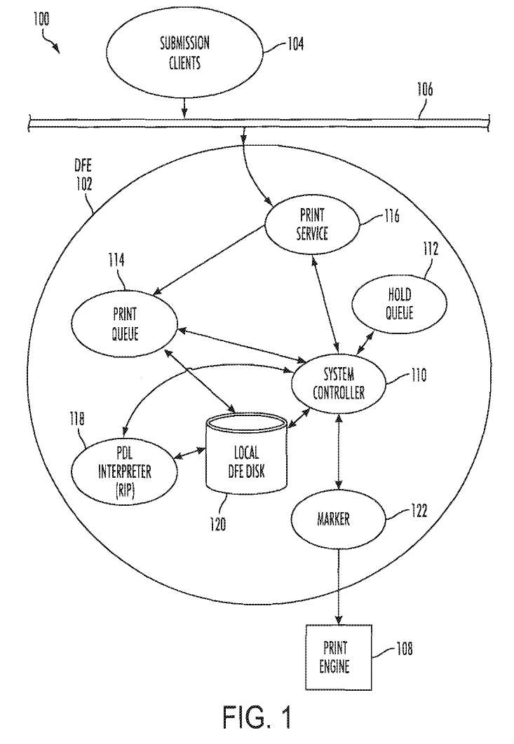

FIG. 1 illustrates an exemplary embodiment of a networked printing system 100 architecture. Although FIG. 1 illustrates a networked printing system 100, exemplary embodiments are intended to encompass other systems, such as copying and scanning systems. The system 100 includes a digital front end (DFE) 102 that receives page descriptions (e.g., PDL files) such as from submission clients 104 over a network 106 for printing by an output device such as a print engine 108. However, the output device could also be a display or scanner.

Submission clients 104 are one or more clients on the network 106 that submit jobs for printing. Some examples of submission clients 104 include computers, scanners, copiers and other computing devices. Each submission client 104 includes a print driver (not shown). The print driver is typically embodied in software stored in memory on the submission client 104. The print driver compiles print job programming attributes (e.g., color attributes) and assembles the attributes and image data into page descriptions for a print job to be processed by the digital front end 102.

The digital front end 102 is a processor that performs raster image processing (RIPping) of the page descriptions for print jobs from the submission clients to produce bitmaps for rendering by the print engine 108, among other functions. Some of the other functions of the digital front end 102 include creating and managing print queues, managing the print engine 108, and providing bitmaps to the print engine 108.

The print engine 108 generally performs the print imaging (or rendering), fixing and paper transport to produce output images corresponding to the bitmaps. Output images may be transported to an output tray or stacker (not shown).

The digital front end 102 may include a system controller 110, a hold queue 112, a print queue 114, a print service 116, a raster image processor (RIP) 118 (e.g., PDL interpreter), a local disk (or storage device) 120, and a marker 122. The system controller 110 includes a processor, memory and software, hardware and/or firmware to generally manage the digital front end 102. For example, the system controller 110 determines which incoming jobs to hold and which jobs are ready to print. The system controller 110 may receive input from an operator using a user interface (not shown). For example, the operator may determine which job to print next. The system controller 110 dispatches jobs from the print queue 114 to the raster image processor 118. The system controller 110 also monitors the state of the raster image processor 118, the marker 122, and the print engine 108.

The hold queue 112 and the print queue 114 may each be single queues or multiple queues. Both queues may be implemented as indexes into one queue. Alternatively a job in the print queue 114 may simply have a held status without there actually being a hold queue 112. The digital front end 102 may include additional queues. Typically, the system controller 110 assigns jobs from submission clients 104 to the hold queue 112 and the operator schedules and releases jobs to the print queue 114. When a job is released to the print queue, the system controller 110 passes the released job to the raster image processor 118 for raster image processing.

The printer service 116 is typically a software server running on the digital front end 102 that provides a selection of printing services to the submission clients 104 and receives incoming print jobs from the submission clients 104 over the network 106. The printer service 116 may send incoming print jobs to the print queue 114 or the system controller 110. The printer service 116 may include a user interface (not shown). The printer service 116 may include one or more network submission gateways and one or more submission queues.

The raster image processor 118 is software, hardware or firmware that translates the page descriptions into a bitmap for output by the print engine 108. The bitmap may be stored in the local disk or storage device 120.

The marker 122 provides data and control information (e.g., font and color information) to the print engine 108 and sends binary RIP data to the print engine 108. The printer engine 108 and marker 122 may be combined into one module or component. The printer engine 108 renders an image based on the bitmap from the raster image processor 118 and the data and control information.

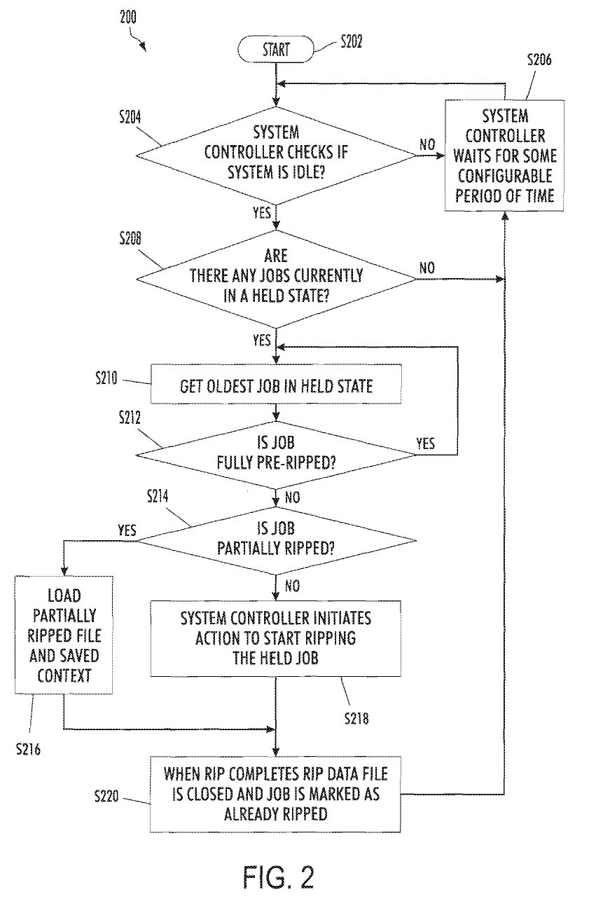

FIG. 2 illustrates an exemplary embodiment of a method 200 for the raster image processing of a held job. The method 200 may be performed in the networked printing system 100 of FIG. 1 or in other systems. A held job may be a print job in the hold queue 112 or a job with a held status in the print queue 114. The raster image processing may be performed generally by the digital front end 102 or specifically by the raster image processor 118. The system controller 110 may determine when the digital front end 102 (or printer) is idle.

Whenever the digital front end 102 is idle, one or more held jobs may be raster image processed while they are still in the hold queue 112 (or have a held status in the print queue 114). Held jobs that are raster image processed while they are still in the hold queue 112, may be stored in the local disk 120 or on another storage device in the digital front end. Such held jobs are raster image processed ahead of the normal sequence for raster image processing. The normal sequence is for the system controller 110 to first release a held job to the print queue 114 and then to direct the job to the raster image processor 118. Held jobs that have been pre-raster image processed are directed by the system controller 110 to the marker and/or print engine 108 for printing without additional raster image processing. This results in a significant performance enhancement over the normal sequence. This is because the time to raster image process a job (i.e., process it by the raster image processor 118) is often a large part of the total printing time and has been done in advance.

The digital front end 102 may be idle at various times throughout the day, even in a production environment. For example, idle conditions may occur between jobs, during paper loading, during manual job programming operations and the like. The system controller 110 may determine when the digital front end 102 is idle and initiate pre-raster image processing of held jobs. Alternately, there may be a special purpose component (software, hardware, or firmware) that monitors the idle or non-idle condition of the digital front end 102 and initiates pre-raster image processing of held jobs at such idle conditions.

The method of FIG. 2 starts at step S202 and advances to step S204, where the system controller 110 determines whether the digital front end 102 is idle. If not, then the system controller 110 waits at step S206 for a configurable period of time before checking again. If the digital front end 102 is determined to be idle at step S204, then the system controller 110 determines whether there are any held jobs. If not, the system controller 110 waits at step S206 and then returns to step S204. If there is more than one held job, the system controller advances to step S211, where the oldest held job is identified.

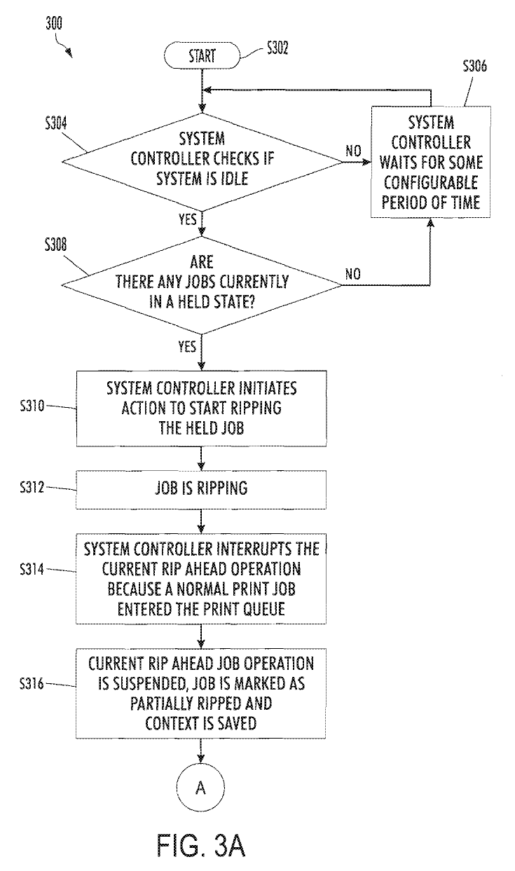

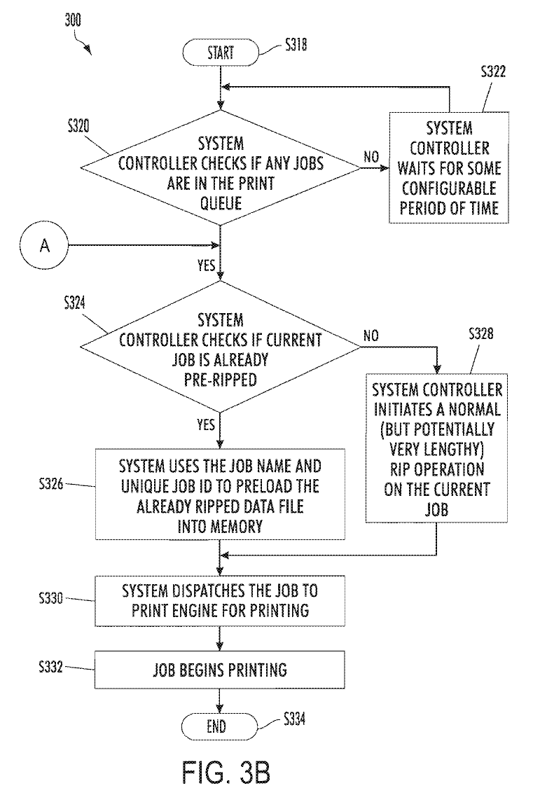

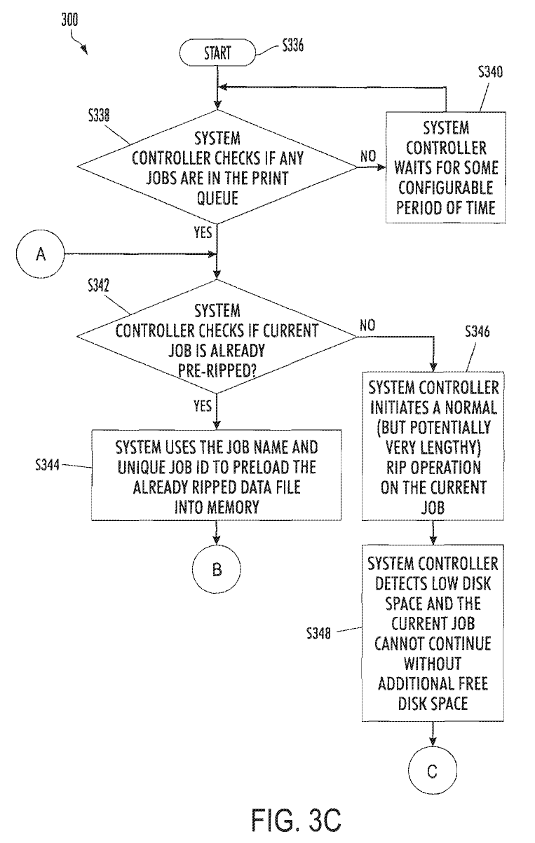

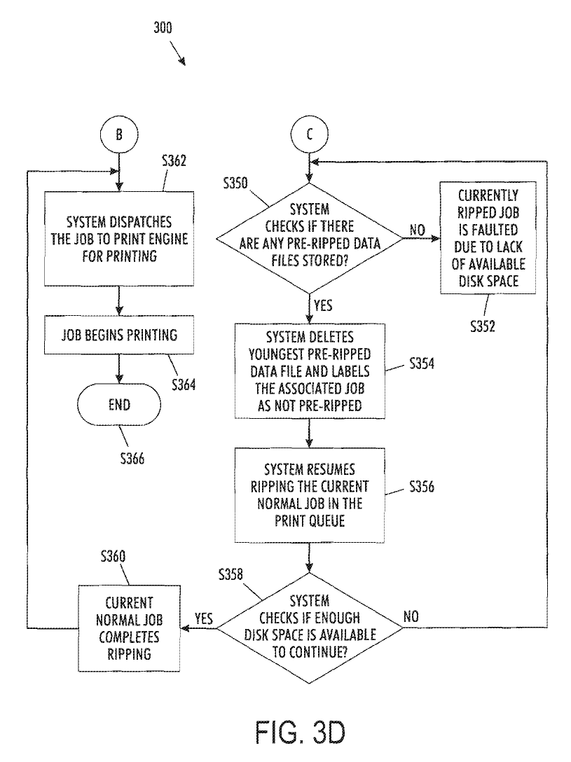

At step S212, the system controller 110 determines whether the held job is fully pre-raster image processed. Some held jobs may be suspended before the raster image processing is complete (see FIGS. 3A-3D). If the held job is not fully pre-raster image processed (or not raster image processed at all), then the system controller 110 identifies the next oldest job at step S210. The system controller will continue looping from step S210 to step S212 until the oldest held job that is fully raster image processed is found at step S212 or, if none, then the oldest held job that is partially raster image processed is found at step S214. Various alternate conditions for selecting the next job to process may be also used.

A job identifier and/or job name may be used to identify jobs and associate jobs with the full or partial bitmaps. Additionally, a status, such as partially raster image processed or fully raster image process, may be associated with jobs.

If a partially raster image processed held job is found at step S214, then at step S216 the system controller 110 retrieves the partial bitmap from the local disk 120. In addition, the system controller 110 retrieves saved context information (e.g., the position in the page description information to resume raster image processing). The system controller 110 directs the raster image processor 118 to complete raster image processing of the partially processed held job. If a fully raster image processed held job was found at step S212, then at step S218 the system controller 110 retrieves the full bitmap from the local disk 120. In either case, at step S220 the system controller 110 sends the bitmap to the marker 122 and/or print engine 108 for printing. This completes the exemplary embodiment of the method 200 of FIG. 2, which illustrates normal uninterrupted raster image processing of a held job.

FIGS. 3A and 3B illustrate an exemplary embodiment of a method 300 for the raster image processing of a held job that is interrupted by a regular job moving to the print queue 114. A regular job may be a higher priority job or the next job in the hold queue 112 to be moved to the print queue 114 when the print engine 108 becomes available after printing the last job. The regular job may be moved to the print queue by the system controller 110 or the operator. When the regular job is moved to the print queue, the regular job takes priority. The held job being raster image processed is accordingly stopped and the partial bitmap and context information may be stored. Then, the raster image processor 118 is free to process the regular job. Alternatively, the raster image processing may simply be abandoned and no information stored so that only fully raster image processed files are used. Various priority schemes other than the regular job taking precedence may also be used.

Raster image processing of held jobs are preferably transparent to the operator. That is, if the operator happens to move a particular job from the hold queue 112 to the print queue 114 while a held job is being raster image processed, the raster image processing of the held job may be automatically temporarily suspended (or abandoned) so that the particular job the operator moved to the print queue 114 may begin to be raster image processed without delay.

The method of FIG. 3A starts at step S302 and advances to step S304, where the system controller 110 determines whether the digital image processor 102 is idle. If not, then at step S306 the system controller 110 waits for a configurable period of time before checking again. If the digital image processor 102 is idle at step S304, then at step S308 the system controller 110 determines whether there are any held jobs. If not, then the system controller at step S306 waits for a configurable period of time before checking again. If there is at least one held job, the system controller 110 determines the oldest held job at step S3110 and initiates raster image processing of the oldest held job at step S312. The held jobs may be associated with a time stamp or other indication of when they were submitted by the submission client 104, assigned to the held queue 112 or some other time marker.

At step S314, the system controller 110 may interrupt the raster image processing of the oldest held job at step S312 because a normal print job is being moved to the print queue 114 and takes priority. The raster image processing of the oldest held job is suspended at step S316 and the partial bitmap and context information may be stored (e.g., byte index into PDL file). Additional information may be stored, such as information correlating held job identifiers and memory locations of bitmaps in the local disk 120. The method of FIG. 3A joins at point “A” to FIG. 3B (or FIG. 3C).

At the start S318 of FIG. 3B, the system controller 110 advances to step S320 and determines whether there are any jobs in the print queue 114. If not, then at step S322 the system controller 110 waits a configurable period of time before checking again. If there is at least one job in the print queue 114, then at step S324 the system control 10 determines whether the current job in the print queue 114 is pre-raster image processed. If not, then at step S328 the system controller 110 initiates raster image processing of the current job. If the current job is pre-raster image processed, then at step S326 the system controller 110 retrieves the bitmap into memory and dispatches the current job to the print engine 108 for printing at step S330. The current job begins printing at step S332 and the method of FIGS. 3A and 3B ends at step S334.

FIGS. 3C and 3D illustrate an exemplary embodiment of a method for raster image processing of a regular job when the system controller 110 purges one or more pre-raster image processed held jobs due to memory constraints. Purging means freeing up space in the local disk 120 (or other memory) to make room for the bitmap of the regular job by deleting pre-raster image processed held job. When the system, such as network printing system 100, has limited memory, the method of FIGS. 3C and 3D may be used to prevent raster image processing held job from interfering with regular processing. Alternatively, more memory may be added to the digital front end 102 of the system 100.

The method 300 of FIGS. 3C and 3D starts at step S336 and advances to step S338 where the system controller 110 determines whether there are any job in the print queue 114. If not, then at step S340 the system controller 110 waits for a configurable period of time before checking again. If there is at least one job in the print queue 114, then at step 8342 the system controller 110 determines whether the current job in the print queue 114 is pre-raster image processed. If not, then at step S346 the system controller 110 initiates a normal raster image processing of the current job. If the current job is pre-raster image processed, then at step S344 the system controller 110 retrieves the bitmap of the current job from the local disk 120.

After the system controller 110 initiates the normal raster image processing of the current job at step S346, the system controller 110 detects that disk space is low on the local disk 120 and the current job cannot continue without additional free disk space at step S348. The system controller determines whether there are any bitmaps for pre-raster image processed held jobs stored on the local disk 120 at step S350. If not, then at step S352 the current job is faulted due to the lack of available disk space. That is, there are no bitmaps for pre-raster image processed held jobs to delete to create free space to continue the current job. If there is at least one bitmap for pre-raster image processed held jobs stored on the local disk 120, then at step S354 the system controller 110 deletes the youngest pre-raster image processed held job stored on the local disk 120. The system controller 110 may also update any raster image processing status associated with the youngest held job. The system controller 110 then resumes raster image processing the current job in the print queue 114 at step S356. At step S358, the system controller 110 again determines whether there is enough disk space available to continue. If not, then returning to step S350, the system controller 110 determines whether there are any bitmaps for pre-raster image processed held jobs stored on the local disk 120. If there is enough disk space to continue, then at step S360 the raster image processing of the current job is completed. Alternatively, the system controller 110 may perform some computation before raster image processing begins for the current job to determine ahead of time whether there is enough disk space. However, for variable data files, this may not be possible. Once the raster image processing of the current job is completed, at step S362 the system controller 110 dispatches the bitmap to the print engine 108 for printing and at step S364 the current job begins printing. The method 300 of FIGS. 3C and 3D ends at step S366.

Pre-raster image processing of held jobs may also be suspended whenever disk space 120 is low. The partial bitmap and other data of the held job may be stored in temporary files on the local disk 120. If several held jobs have been raster image processed while in the hold queue 112, but not yet printed, a next job entering the print queue 114 may cause the temporary data of the pre-raster image processed held jobs to be flushed in order to make disk space available for the current job.

Exemplary embodiments can have many advantages. The operator and submission client 104 experience a significant performance enhancement whenever printing held jobs that were pre-raster image processed while in the hold queue 112. Normal print jobs continue to be processed without interference. This is because the method may be suspended whenever other jobs move from the hold queue 112 to the print queue 114. There is no negative impact to available disk space, because pre-raster image processed held jobs may automatically be flushed when disk space becomes low. There also is no loss in processing speed of print jobs, because such jobs can interrupt the pre-raster processing. Thus, pre-raster image processing held jobs is transparent to the operator and submission client 104. The performance of raster image processing is increased for a low cost, because no hardware upgrade is needed and there is no decrease in performance for regular jobs going directly into the print queue 114.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of raster image processing held jobs when a digital front end is idle, comprising:
determining that the digital front end is idle;
raster image processing at least one held job to produce at least one bitmap, while the digital front end is idle; and
storing the bitmap in a memory associated with the digital front end.

2. The method of claim 1, further comprising:
sending the stored bitmap to an output device for rendering.

3. The method of claim 1, further comprising:
determining that the at least one held job was already raster image processed;
retrieving the bitmap from the memory; and
sending the retrieved bitmap to an output device for rendering without additional raster image processing.

4. The method of claim 3, wherein the at least one held job is a plurality of held jobs and further comprising:
searching for the oldest held job that was already raster image processed; and
retrieving the bitmap for the oldest held job from the memory.

5. The method of claim 1, wherein the stored bitmap is a partial bitmap and further comprising:
suspending the raster image processing of the held job upon receipt of an interrupt to process a priority job; and
storing context information about the partial bitmap.

6. The method of claim 5, further comprising:
resuming raster image processing of the held job using the stored context information, when the digital front end again becomes idle.

7. The method of claim 5, further comprising:
raster image processing of a regular job.

8. The method of claim 5, further comprising:
purging a bitmap of at least one held job from the memory upon receiving an interrupt or an indication that memory is low.

9. The method of claim 8, further comprising:
pausing the raster image processing of the regular job until the memory is purged.

10. The method of claim 1, further comprising:
suspending the raster image processing of the held job and purging a youngest stored bitmap, upon receiving an indication that memory is low;
marking a job associated with the youngest stored bitmap as not pre-raster image processed; and
resuming raster image processing of the held job using stored context information, when the digital front end again becomes idle.

11. A digital front end for raster image processing held jobs when the digital front end is idle, comprising:
a system controller for receiving at least one page description and making the at least one page description into at least one job, the at least one job including at least one held job held in at least one queue;
a raster image processor for raster image processing the at least one held job to produce at least one bitmap while the digital front end is idle; and
a memory for storing the at least one bitmap.

12. The digital front end of claim 11, wherein the digital front end further comprises:
a print service in communication with the system controller for receiving the at least one page description from a submission client.

13. The digital front end of claim 11, wherein the at least one queue for holding the at least one job includes at least one regular job and the at least one held job.

14. The digital front end of claim 13, wherein the at least one queue comprises a print queue for holding the at least one regular job and a hold queue for holding the held jobs.

15. The digital front end of claim 11, wherein the system controller suspends the raster image processing of the held job and purges a youngest stored bitmap upon receiving an indication that the memory is low, marks a job associated with the youngest stored bitmap as not pre-raster image processed, and resumes raster image processing of the held job using stored context information about the suspended held job when the digital front end again becomes idle.

16. A print system comprising:
the digital front end of claim 11; and
a print engine connected to the digital front end for receiving and outputting the at least one bitmap.

17. The print system of claim 16, wherein the print engine is one of a printer or a copier.

18. A computer readable medium storing instructions for performing a method of raster image processing held jobs when a digital front end is idle, the method comprising:
determining that the digital front end is idle;
raster image processing at least one held job to produce at least one bitmap, while the digital front end is idle; and
storing the bitmap in a memory associated with the digital front end.

19. The computer readable medium of claim 18, further comprising:
sending the stored bitmap to an output device for rendering.

20. The computer readable medium of claim 18, further comprising:
determining that the at least one held job was already raster image processed;
retrieving the bitmap from the memory; and
sending the retrieved bitmap to a output device for rendering without additional raster image processing.

21. The computer readable medium of claim 20, wherein the at least one held job is a plurality of held jobs and further comprising:
searching for the oldest held job that was already raster image processed; and
retrieving the bitmap for the oldest held job from the memory.

22. The computer readable medium of claim 18, wherein the stored bitmap is a partial bitmap and further comprising:
suspending the raster image processing of the held job upon receipt of an interrupt to process a priority job; and
storing context information about the partial bitmap.

23. The computer readable medium of claim 22, further comprising:
resuming raster image processing of the held job using the stored context information, when the digital front end again becomes idle.
